(19) United States
(12) Patent Application Publication
(10) Pub. No.: US 2018/0022577 A1
(43) Pub. Date: Jan. 25, 2018

(54) ELEVATOR MONITOR

(71) Applicant: Hin Wah Marco NG, Tseung Kwan O (HK)

(72) Inventor: Hin Wah Marco NG, Tseung Kwan O (HK)

(21) Appl. No.: 15/653,652

(22) Filed: Jul. 19, 2017

(30) Foreign Application Priority Data
Jul. 21, 2016 (HK) 16108773.8

(51) Int. Cl. B66B 5/00; B66B 3/00

(52) U.S. Cl. CPC B66B 5/0018; B66B 3/002

(57) ABSTRACT

An elevator monitor as disclosed in the present utility model includes an upper cover and a bottom case, with the upper cover fixed to the opening position of the bottom case and a control panel provided in the inner space of the bottom case. The control panel includes a PCB board, a floor interpretation processor, an elevating speed recording and analyzing processor, an AV line inlet, a data line inlet, an AV line outlet, a data line outlet, a control switch, an LED indicator and a buzzer. The present utility model relates to an elevator monitor, which is of a structure being able to detect the stability of the elevator in seconds and prevent the phenomenon of abnormal drop. When the car of the elevator is caught in the hoistway, it will be convenient for workers to find the elevator in time for maintenance and rescue, thus improving safety, effect of use and practicality. Furthermore, the camera can detect whether the elevator door is blocked and monitor whether the elevator door can be closed.

### TECHNICAL FIELD

The present utility model relates to an electronic device in an elevator, particularly to an elevator monitor.

### BACKGROUND

The existing elevator control systems can generally exert simple control on moving up and down and opening/closing of the door only and are not provided with more advanced functions such as real-time monitoring and danger monitoring. Moreover, the existing elevator control systems can generally observe the number of floor at the doorway of the elevator or in the car of the elevator only and can not observe the operating speed of the elevator car as it is moving up and down. However, the car of the elevator is liable to the phenomenon of abnormal drop in the process of moving up and down. When the elevator door fails with the result that the opening or the closing of the door is blocked, it will be impossible to get the accurate information on floor immediately, and manual troubleshooting or manual reporting will be required for obtaining data, thus resulting in a certain potential safety hazard and affecting the effect of use and practicality.

Therefore, in view of the above-mentioned disadvantages of common prior art, the inventor carries out research and improvement on the foregoing disadvantages and finally generates the present utility model.

### SUMMANY

The object of the present utility model is to design an elevator monitor which can improve the effect of use and practicality with an aim to solve the above-mentioned technical disadvantages.

An elevator monitor as designed in the present utility model includes an upper cover and a bottom case, with the upper cover fixed to the opening position of the bottom case and a control panel provided in the inner space of the bottom case, which is characterized in that: the control panel includes a PCB board, a floor interpretation processor, an elevating speed recording and analyzing processor, an AV line inlet, a data line inlet, an AV line outlet, a data line outlet, a control switch, an LED indicator and a buzzer, with the signal received by the data line inlet input to the elevating speed recording and analyzing processor and processed by the elevating speed recording and analyzing processor before being input to the data line outlet, the buzzer and the LED indicator respectively, and the signal received by the AV line inlet input to the floor interpretation processor and processed by the floor interpretation processor before being input to the AV line outlet.

Furthermore, the control panel further includes a power connector and a transformer electrically connected to each other, with the transformer electrically connected to the floor interpretation processor, the elevating speed recording and analyzing processor, the control switch, the LED indicator and the buzzer respectively.

Furthermore, it further includes a display screen, with the AV line outlet signal-connected to the display screen.

Furthermore, it further includes a sensor, with the data line inlet signal-connected to the sensor, and, the sensor includes a sensing element and a level meter signal-connected to each other, with the level meter signal-connected to the data line inlet.

Furthermore, it further includes a camera, with the AV line inlet signal-connected to the camera.

The present utility model designs an elevator monitor, which is of a structure being able to detect the stability of the elevator in seconds and prevent the phenomenon of abnormal drop. When the car of the elevator is caught in the hoistway, it will be convenient for workers to find the elevator in time for maintenance and rescue, thus improving safety, effect of use and practicality. Furthermore, the camera can detect whether the elevator door is blocked and monitor whether the elevator door can be closed.

### DESCRIPTION OF THE DRAWINGS

FIG. 1 is a schematic diagram of the overall structure of Embodiment 1;

FIG. 2 is an exploded diagram of Embodiment 1.

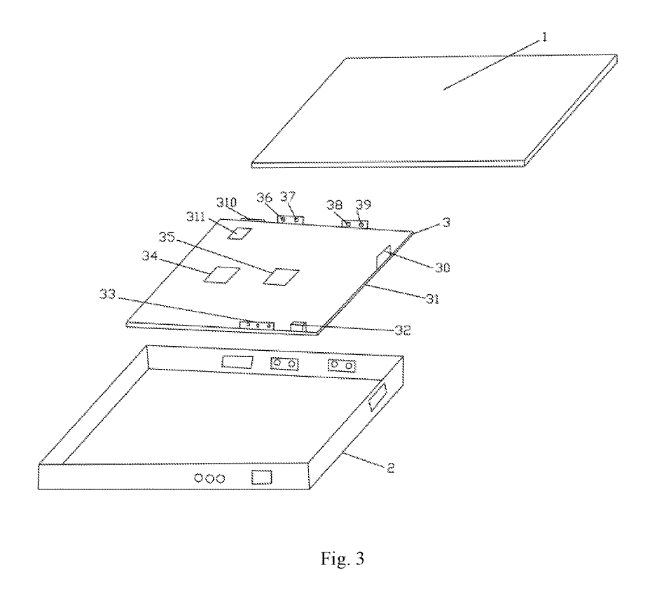

In the figure: upper cover 1, bottom case 2, control panel 3, control switch 30, PCB board 31, buzzer 32, LED indicator 33, floor interpretation processor 34, elevating speed recording and analyzing processor 35, AV line inlet 36, data line inlet 37, AV line outlet 38, data line outlet 39, power connector 310, transformer 311, display screen 4, sensor 5, sensing element 51, level meter 52, camera 6.

### DETAILED DESCRIPTION OF THE PREFERRED EMBODIMENT

Below, the technical solution in the embodiment of the present utility model will be clearly and completely described in conjunction with the drawings in the embodiment of the present utility model. Apparently, the embodiment described is only a part of the embodiments of the present utility model and not all of the embodiments. Based on the embodiment in the present utility model, all other embodiments obtained by those skilled in the art will fall within the scope of protection of the present utility model.

### Embodiment 1

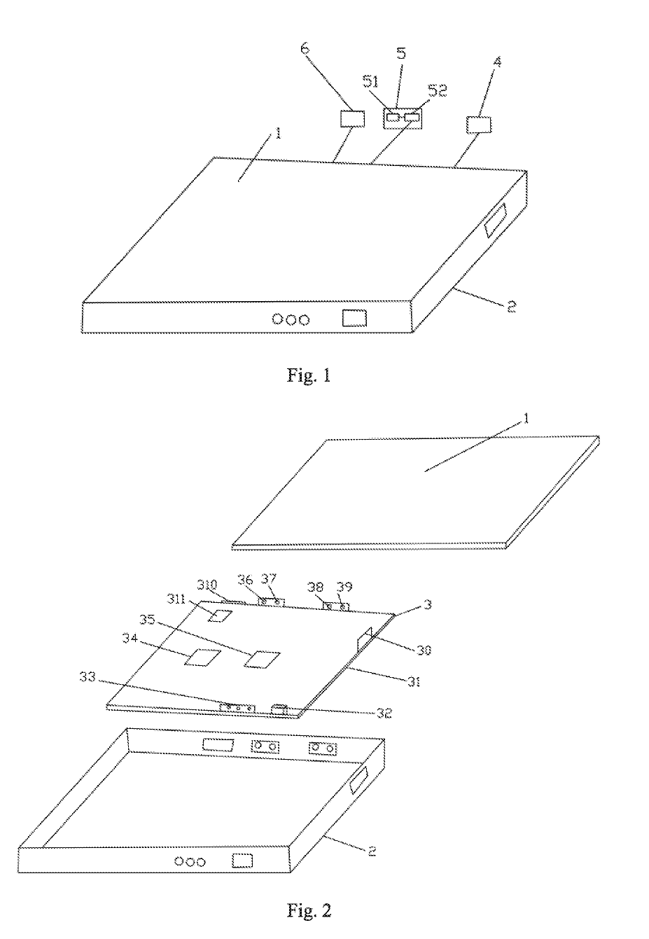

As shown in FIG. 1, an elevator monitor as described in this embodiment includes an upper cover 1 and a bottom case 2, with the upper cover 1 fixed to the opening position of the bottom case 2 and a control panel 3 provided in the inner space of the bottom case 2. The control panel 3 includes a PCB board 31, a floor interpretation processor 34, an elevating speed recording and analyzing processor 35, an AV line inlet 36, a data line inlet 37, an AV line outlet 38, a data line outlet 39, a control switch 30, an LED indicator 33 and a buzzer 32, with the signal received by the data line inlet 37 input to the elevating speed recording and analyzing processor 35 and processed by the elevating speed recording and analyzing processor 35 before being input to the data line outlet 39, the buzzer 32 and the LED indicator 33 respectively, and the signal received by the AV line inlet 36 input to the floor interpretation processor 34 and processed by the floor interpretation processor 34 before being input to the AV line outlet 38.

In this embodiment, the control panel 3 further includes a power connector 310 and a transformer 311 electrically connected to each other, with the transformer 311 electrically connected to the floor interpretation processor 34, the elevating speed recording and analyzing processor 35, the control switch 30, the LED indicator 33 and the buzzer 32 respectively, thus its structure performs the role of controlling the turning-on and turning-off of the control panel 3 of the monitor by means of the control switch 30 and providing circuit protection and preventing overload damage for the elements such as the processor, the control switch 30, the LED indicator 33 and the buzzer 32, etc. by means of the transformer 311.

In this embodiment, it further includes a display screen 4, with the AV line outlet 38 signal-connected to the display screen 4, thus displaying in real time the situations in the car, the opening or closing of the door after the car reaches each floor as well as the specific data and floor number when the car reaches each floor.

In this embodiment, it further includes a sensor 5, with the data line inlet 37 signal-connected to the sensor 5, and, the sensor 5 includes a sensing element 51 and a level meter 52 signal-connected to each other, with the level meter 52 signal-connected to the data line inlet 37, thus making the level meter 52 signal-connected to the floor interpretation processor 34 by means of the data line inlet 37 so as to facilitate the sensing of the floor and improve the effect of use, and moreover, it is able to sense whether the car in the elevator is leveled or vibrate when it stops on a floor and measure the deviation of balance by means of the level meter 52.

In this embodiment, it further includes a camera, with the AV line inlet 36 signal-connected to the camera, thus monitoring or collecting the images in the car in real time and recording and saving the images automatically with the result of improving practicality.

Operating principle: by connecting the elevator to the floor interpretation processor 34 of the monitor, it will be able to see the elevating floor from the screen in the monitoring room, that is, if the elevator is on the 3rd floor, the number 3 will appear on the screen in the monitoring room, and the number of floor will flash as the elevator moves up and down; the elevating speed recording and analyzing processor 35 of the monitor in this embodiment can detect the stability of the elevator in seconds, that is, if the elevator operates at a speed faster than the usual speed, the monitor will give a warning signal or print out data through a printer, for example, it the elevator suddenly drops from the 10th floor to the 8th floor, the operating speed will be abnormal, then data will appear, and a warning signal will be given.

The present utility model is not limited to the above preferred embodiment, and any person may obtain other products in various forms under the revelation of the present utility model. However, regardless of any changes in the shape or structure, any technical solutions same as or similar to the present application should fall within the scope of protection of the present utility model.

1. An elevator monitor, comprising an upper cover and a bottom case, the upper cover being fixed to the opening position of the bottom case and a control panel provided in the inner space of the bottom case, the control panel comprising a PCB board, a floor interpretation processor, an elevating speed recording and analyzing processor, an AV line inlet, a data line inlet, an AV line outlet, a data line outlet, a control switch, an LED indicator and a buzzer, with the signal received by the data line inlet input to the elevating speed recording and analyzing processor and processed by the elevating speed recording and analyzing processor before being input to the data line outlet, the buzzer, and the LED indicator, and the signal received by the AV line inlet being input to the floor interpretation processor and being processed by the floor interpretation processor before being input to the AV line outlet.

2. The elevator monitor according to claim 1, wherein the control panel further comprises a power connector and a transformer electrically connected to each other, with the transformer being electrically connected to the floor interpretation processor, the elevating speed recording and analyzing processor, the control switch, the LED indicator, and the buzzer.

3. The elevator monitor according to claim 1, further comprising a display screen, with the AV line outlet being signal-connected to the display screen.

4. The elevator monitor according to claim 1, further comprising a sensor, with the data line inlet signal-connected to the sensor, the sensor comprising a sensing element and a level meter signal-connected to each other, with the level meter being signal-connected to the data line inlet.

5. The elevator monitor according to claim 1, further comprising a camera, with the AV line inlet being signal-connected to the camera.
